(19) United States
(12) Patent Application Publication
(10) Pub. No.: US 2026/0100136 A1
(43) Pub. Date: Apr. 9, 2026

(54) GENERATING PERSONALIZED COACHING ADVICE USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Pedro Ricardo Gomes Dias, Hong Kong (CN); Zoltan Szalontai, Keckskemet (HU); Ricardo Sion Mahfoud, Zouk Mikael (LB); Kaan Ozdokmeci, Ordino (AD)

(73) Assignee: 2hr Learning, Inc., Austin, TX (US)

(21) Appl. No.: 19/352,365

(22) Filed: Oct. 7, 2025

Related U.S. Application Data
(60) Provisional application No. 63/704,528, filed on Oct. 7, 2024.

(51) Int. Cl. G09B 5/02; G06F 40/40

(52) U.S. Cl. CPC G09B 5/02; G06F 40/40

(57) ABSTRACT

A personalized coaching advice generation system and method collects media stream data and user interaction data. Machine learning algorithms analyze media stream data and user interaction data to identify specific learning patterns, which are then classified into positive (posi-patterns) and negative (anti-patterns) categories. The personalized coaching advice generation system and method generate coaching prompts based on these patterns and a predefined prompt structure created by the prompt engineer. An AI engine uses these prompts to create personalized coaching advice, which is then displayed to the user through an online learning platform. The personalized coaching advice addresses specific behaviors detected during the learning session and suggests corrective actions to improve learning efficiency. The personalized coaching advice generation system and method also include features for calculating learning time wastage.

### CROSS-REFERENCE TO RELATED APPLICATION(S)

This application claims the benefit under 35 U.S.C. § 119 (c) and 37 C.F.R. § 1.78 of U.S. Provisional Application No. 63/704,528, which are incorporated by reference in its entirety.

### FIELD OF THE INVENTION

The present invention generally relates to the field of electronics, and more specifically to personalized coaching advice generation system, and method, designed to enhance the effectiveness of personalized coaching for users.

### DESCRIPTION OF THE RELATED ART

Educational systems have evolved significantly over time, from traditional classroom-based learning to modern online platforms. The traditional education system relies heavily on in-person interactions between teachers and students, with limited ability to personalize instruction or track individual learning patterns. As technology advances, online learning platforms have emerged, offering users the flexibility to learn at their own pace and from any location.

Traditional educational software emerged as a tool to support learning processes. The traditional educational software typically provides feedback based on static data such as quiz scores, completion rates, and manual inputs from educators. The traditional educational software often includes some form of analytics to track user progress over time. The feedback in the traditional educational software is generally based on predefined criteria and does not account for individual learning patterns or real-time behavioral data.

Adaptive learning platforms use algorithms to adjust content and pace based on user performance, including some analytics to personalize the learning experience. The adaptive learning platforms typically focus on adapting learning content rather than providing insights and coaching based on observed learning behaviors and habits.

Learning management platforms became popular in educational institutions and corporate training environments. The learning management platforms centralize course materials, assignments, and assessments, facilitating course administration and user progress tracking. The learning management platforms offer analytics on user performance, tracking metrics like time spent on tasks and completion rates.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary personalized coaching advice generation system.

FIG. 2 depicts an exemplary personalized coaching advice generation method, utilized by the personalized coaching advice generation system.

FIG. 3 depicts a flow for the personalized coaching advice generation method, which is an embodiment of the personalized coaching advice generation method of FIG. 2.

FIG. 4 depicts a data structure for personalized coaching advice generation.

FIG. 5 depicts a data structure for a time-waste calculator.

FIG. 6 depicts a representation of an educational tool named ‘StudyReel’ for the personalized coaching advice generation system, which is an embodiment of the personalized coaching advice generation method of FIG. 2.

FIG. 7 depicts an exemplary user interface for displaying personalized coaching advice.

FIG. 8 depicts an exemplary network environment in which the system of FIG. 1 and the process of FIG. 2 may be practiced.

FIG. 9 depicts an exemplary computer system.

### DETAILED DESCRIPTION

A personalized coaching advice generation system and method designed to enhance the effectiveness of personalized coaching for users. The personalized coaching advice generation system and method collects data from different data sources, such as media stream data 110 and user interaction data 112. A coaching advice planning module 114 recipes the data from memory 108 including media stream data 110 and user interaction data 112. Inside the coaching advice planning module 114, the data is collected and analyzed, and a prompt is generated. An AI engine 124 receives the prompt from the coaching advice planning module 114 and generates personalized coaching advice. An online learning platform 104 receives the generated personalized coaching advice from the AI engine 124 and displays personalized coaching advice through a user interface 106.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not even recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

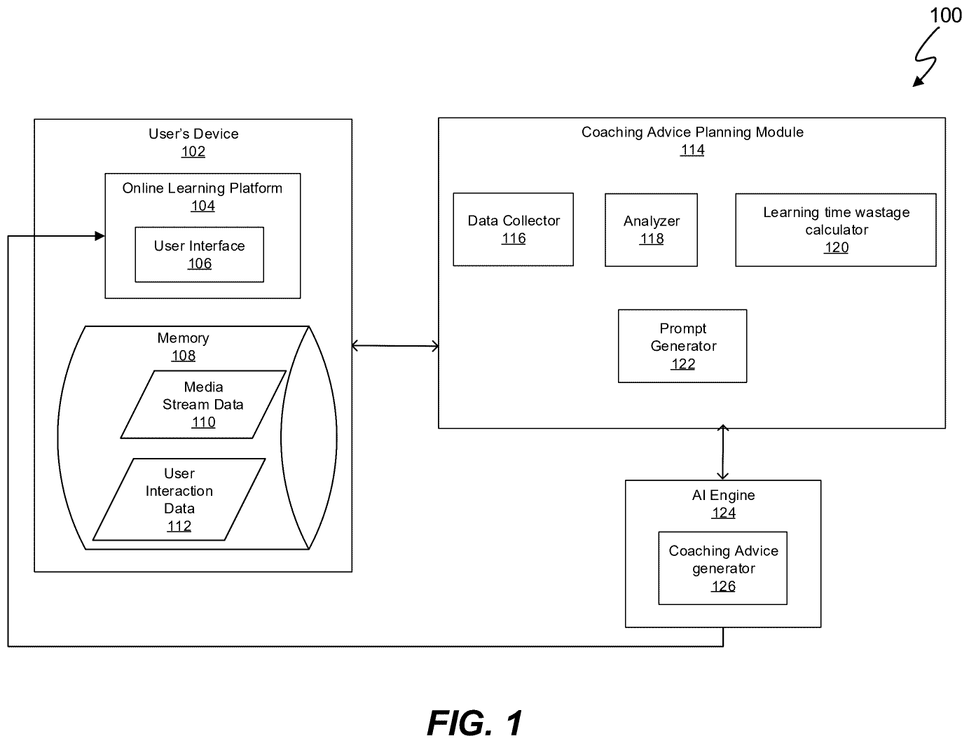

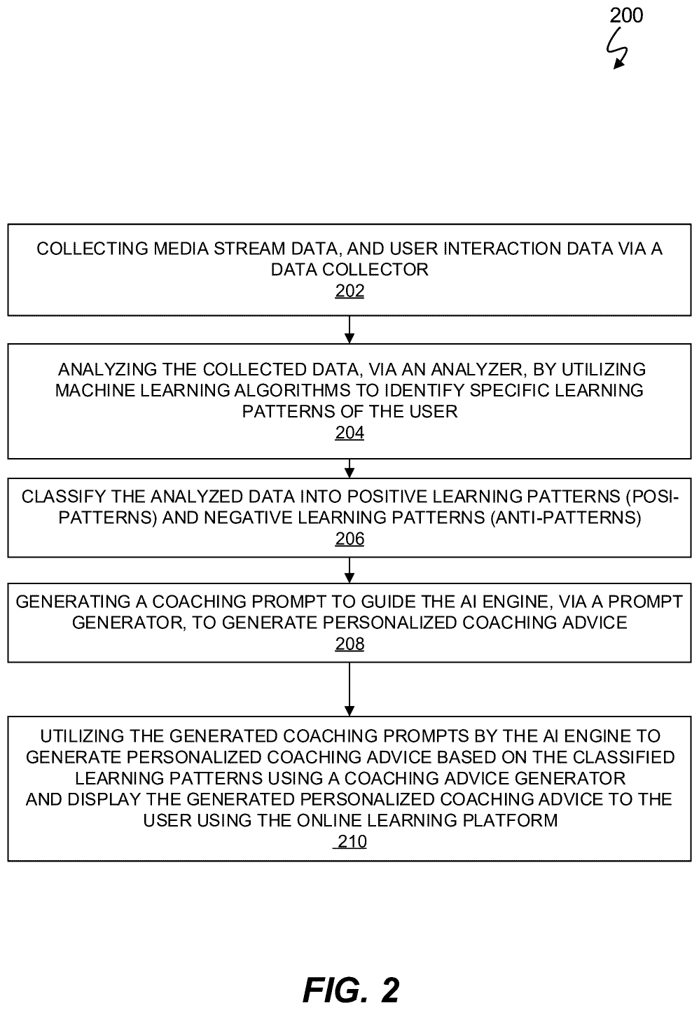

FIG. 1 depicts an exemplary personalized coaching advice generation system, and FIG. 2 depicts an exemplary personalized coaching advice generation method, utilized by the personalized coaching advice generation system. Referring to FIGS. 1 and 2, in operation 202, a data collector 116 collects media stream data 110 and user interaction data 112. The media stream data 110 and user interaction data 112 are collected from a user's device 102 and stored in the memory 108 present in the user's device 102. The media stream data 110 and user interaction data 112 are collected in real-time from the user's device 102 when a user uses the online learning platform 104. The media stream data 110 and user interaction data 112 won't be collected when the user is not using the online learning platform 104.

The media stream data 110 includes data from a webcam feed capturing real-time video from the user's camera. The webcam feed typically includes live visual content of the user or the environment around users. A microphone audio recorder records sound through the user's microphone, capturing the user's voice or any other audible inputs in the surroundings. Screen capture involves capturing images or videos of the user's computer screen and documenting whatever is being displayed, such as applications, documents, or other on-screen activities. System audio refers to the audio output generated by the computer system itself, including sounds from applications, videos, or music being played on the device.

The user interaction data 112 includes data related to 1) Keystrokes-capturing user input when the keys are pressed by the user on the keyboard 2) Mouse clicks-capturing each click made by the user with their mouse, including the location of the cursor on the screen when the click occurred 3) URLs visited-data from the web addresses visited by the user, providing a history of websites accessed 4) Active applications-capturing data related to applications that are currently running on user's device 102. 5) Active window data records-capturing which window is currently active or in focus, indicating what the user is interacting with at any given moment, and 6) Window titles-capturing the title of active windows, often reflecting the content or purpose of the window, such as the title of a document, a webpage, or an application.

The method for generating personalized coaching advice based on user interaction data and learning patterns stores the media stream data 110 and user interaction data 112 in memory 108 for future retrieval and performs daily storage. For example, if a user needs to analyze progress over a specific period, they can access the collected data from the memory. The user can provide comments to the online learning platform 104 to access data collected by the media stream data 110 module and user interaction data 112 module, which is then processed by the method for generating personalized content.

In at least one embodiment, the data collector 116 collects data from memory 108 in the user's device and converts them into editable and searchable data. The conversion of the data collected from memory 108 is done with the help of OCR (optical character recognition) developed by AWS (amazon web service). OCR (Optical Character Recognition) is a technology that converts different types of documents, such as scanned paper documents, PDFs, or images captured by a digital camera, into editable and searchable data. OCR works by analyzing the structure of a document image and recognizing the characters in the text. AWS (Amazon Web Services) is a comprehensive cloud computing platform provided by Amazon headquarters, located in Seattle, Washington, USA.

In operation 204, an analyzer 118 analyzes the collected data, by utilizing machine learning algorithms to identify specific learning patterns of the user. The analyzer 118 receives the data collected by the data collector 116. The analyzer 118 analyzes a variety of data and some of the examples are the following:

‘Skipping review center’, where the user bypasses the review center without completing the necessary practice, which could lead to gaps in understanding. ‘Did not take IXL Diagnostics when required’, where the user fails to complete the diagnostics test that identifies their learning level. Distracted, where the user is chatting to colleagues while working on a skill, such as the user talks to peers instead of focusing on the task at hand. Excessive starting over, the user frequently restarts tasks instead of completing them, to avoid difficult questions. Idling while working on a skill, the user is inactive or taking too long to progress through the material. Ignoring explanations after mistakes, the user does not review explanations provided after making errors. Leaving a seat while working on a skill, the user leaves their workstation frequently, disrupting their focus. Listening to music while working on a skill, the user listens to music, which might distract him from the learning activity. Not finishing a lesson before starting a new one, the user starts a new lesson without completing the previous one. Not following the recommended order of skills, the user works on tasks out of the recommended sequence, possibly missing crucial foundational skills. Not taking an assigned quiz, The user ignores or skips quizzes that are part of the lesson. Not watching mandatory instructional videos, the user skips videos that are required to understand the material. Playing with the computer unproductively, where the user uses the computer for activities unrelated to their lesson. Repeating mastered topics, the user continues to work on topics they have already mastered instead of moving on to new challenges. Rushing guiding questions, the user quickly answers guiding questions without taking the time to understand them. Rushing questions, where the user answers questions too quickly often leading to mistakes. Rushing through reading and comprehension texts, where the user skims through reading passages missing key details. Selecting skills of a different Lexile level, where the user chooses tasks that are either too easy or too difficult, not aligned with their level. Surfing or browsing the web while working on a skill, the user uses the internet for unrelated activities during a lesson. Too many tabs open, when the user has multiple browser tabs open, leading to potential distractions. Using audio support or the read-aloud feature for reading comprehension skills, when the user relies on the audio feature instead of reading the text, which may hinder their reading development. Using audio support without reading along, the user listens to the audio without following the text, which can reduce comprehension. Using external tools or sources, the user uses unauthorized tools or websites to complete tasks, potentially cheating. Webcam covered or mispositioned, the user's webcam is not properly positioned, preventing proper monitoring during the lesson. Working on non-recommended skills, the user focuses on skills that are not part of the recommended learning path. In a loud or distracting environment, the user is in a noisy or disruptive setting, which can affect their concentration. The user is in distress, when the user appears to be upset or troubled, which could impact their ability to focus.

Following the correct order of recommendations, the user completes tasks in the recommended sequence, ensuring they build on previous knowledge. Reading explanations after mistakes, the user reviews explanations for their errors, which helps them learn from mistakes. Reading the question carefully before answering correctly, the user takes the time to read and understand questions before responding, leading to accurate answers. Watching mandatory instructional videos, the user watches all required instructional videos, which aids in their understanding of the material.

The analyzer 118 uses ML (machine learning) and MMLM (mixed multi-level model) to analyze the data collected by the data collector 116. The ML and MMLM models. The ML involves training algorithms to learn patterns from data. The ML is enabled to make predictions or decisions without being explicitly programmed for each task. MMLM analyzes data with nested or hierarchical structures. MMLM accounts for variability at multiple levels, providing insights into complex relationships within the data.

In operation 206, analyzer 118 classifies the analyzed data into posi-patterns (positive learning patterns) and anti-patterns (negative learning patterns). The analyzer 118 collects and classifies the data as posi-patterns or anti-patterns with the help of ML and MMLM. For the classification of data, ML and MMLM are fed with required data, which helps to identify which is posi-pattern and anti-pattern.

The data feed to ML and MMLM for the classification of data is given in below table:

| | | | SR wastage | |
|---|---|---|---|---|
| | | | calculation | |
| | | | per instance | |
| name | type | category | (secs) | Notes/Rationale |
| ANTI \| (Knewton) | App- | Disregarding | 0 | |
| Skipping Review | usage AP | key content | | |
| Center | | | | |
| ANTI \| Did not take | App- | Disregarding | 0 | |
| IXL Diagnostics | usage AP | key content | | |
| when required | | | | |
| ANTI \| Distracted | Time- | Not engaging | Clip length | Assumes clip captures the |
| chatting to | wasting | with content | | entirety of the behavior |
| colleagues while | AP | | | (possibly capped) |
| working on a skill | | | | |
| ANTI \| Excessive | App- | Unproductive | 60 | Assumes clip captures the |
| starting over | usage AP | use of app | | entirety of the behavior |
| | | | | (possibly capped) |
| ANTI \| Idling while | Time- | Not engaging | Clip length | Assumes clip captures the |
| working on a skill | wasting | with content | | entirety of the behavior |
| | AP | | | (possibly capped) |
| ANTI \| Ignoring | App- | Disregarding | 60 sec | If the student gets a |
| explanations after | usage AP | key content | | question wrong and then |
| mistakes | | | | disregards the explanation, |
| | | | | then the time spend on the |
| | | | | question was wasted, since |
| | | | | they didn't learn anything |
| | | | | from their mistake. |
| ANTI \| Leaving seat | Time- | Not engaging | Clip length | Assumes clip captures the |
| while working on a | wasting | with content | | entirety of the behavior |
| skill | AP | | | (possibly capped) |
| ANTI \| Listening to | App- | Unproductive | 0 | According to science, the |
| music while working | usage AP | use of app | | impact of listening to music |
| on a skill | | | | varies across students, music |
| | | | | genre, whether it has lyrics |
| | | | | or not, and task complexity. |
| | | | | Won't flag time wastage until |
| | | | | we take a more sophisticated |
| | | | | approach |
| ANTI \| Not | App- | Working on the | 60 sec | Proxy for time required to |
| finishing lesson | usage AP | wrong content | | get back in the zone to |
| before starting new | | | | finish the unfinished skill |
| one | | | | after an interruption. |
| ANTI \| Not | App- | Working on the | 30 sec | Proxy for the inefficiency |
| following the | usage AP | wrong content | | introduced by working on a |
| recommended order | | | | skill the student is |
| of skills | | | | unprepared for. |
| ANTI \| Not taking | App- | Disregarding | 0 | |
| an assigned quiz | usage AP | key content | | |
| ANTI \| Not watching | App- | Disregarding | 0 | |
| mandatory | usage AP | key content | | |
| instructional videos | | | | |
| ANTI \| Playing with | Time- | Unproductive | Clip length | Assumes clip captures the |
| the computer | wasting AP | use of app | | entirety of the behavior |
| unproductively | | | | (possibly capped) |
| ANTI \| Repeating | App- | Working on the | 60 sec | Assumes clip captures the |
| mastered topics | usage AP | wrong content | | entirety of the behavior |
| | | | | (possibly capped) |
| ANTI \| Rushing | App- | Unproductive | 0 | Assumes clip captures the |
| Guiding Questions | usage AP | use of app | | entirety of the behavior |
| | | | | (possibly capped) |
| ANTI \| Rushing | App- | Unproductive | Clip length | Assumes clip captures the |
| questions | usage AP | use of app | | entirety of the behavior |
| | | | | (possibly capped) |
| ANTI \| Rushing | App- | Unproductive | Clip length | Assumes clip captures the |
| through reading | usage AP | use of app | | entirety of the behavior |
| comprehension texts | | | | (possibly capped) |
| ANTI \| Selecting | App- | Working on the | 60 sec | |
| skills of a different | usage AP | wrong content | | |
| level/lexile | | | | |
| ANTI \| Surfing/ | Time- | Not engaging | Clip length | Assumes clip captures the |
| Browsing | wasting | with content | | entirety of the behavior |
| the web while | AP | | | (possibly capped) |
| working on a skill | | | | |
| ANTI \| Too many | Time- | Unproductive | 0 | Time wasted is already |
| tabs open | wasting | use of app | | captured by the |
| | AP | | | “surfing/brownsing” AP |
| ANTI \| Using audio | App- | Unproductive | Clip length | Assumes clip captures the |
| support/read | usage AP | use of app | | entirety of the behavior |
| aloud feature for | | | | (possibly capped) |
| reading | | | | |
| comprehension | | | | |
| skills | | | | |
| ANTI \| Using audio | App- | Unproductive | Clip length | Assumes clip captures the |
| support without | usage AP | use of app | | entirety of the behavior |
| reading along | | | | (possibly capped) |
| ANTI \| Using | App- | Using | Clip length | Assumes clip captures the |
| external | usage AP | unauthorized | | entirety of the behavior |
| tools/sources | | content | | (possibly capped) |
| ANTI \| Webcam | App- | Compromising | 0 | |
| covered or | usage AP | the setup | | |
| mispositioned | | | | |
| ANTI \| Working on | App- | Working on the | 60 sec | |
| non-recommended | usage AP | wrong content | | |
| skills | | | | |
| No antipatterns | Other | | | |
| found | | | | |
| OTHER \| Loud or | Other | External factors | | |
| distracting | | | | |
| environment | | | | |
| OTHER \| Student in | Other | External factors | | |
| distress | | | | |
| POSI \| Following | Posipattern | Working on the | | |
| the correct order | | correct content | | |
| of recommendations | | | | |
| POSI \| Reading | Posipattern | Making use of | | |
| explanations after | | key content | | |
| mistakes | | | | |
| POSI \| Reading the | | | | |
| question carefully | Posipattern | Productive use | | |
| before answering | | of app | | |
| correctly | | | | |
| POSI \| Watching | | | | |
| mandatory | Posipattern | Making use of | | |
| instructional | | key content | | |
| videos | | | | |

For example, if a user is distracted by chatting with colleagues while working on a skill, analyzer 118 will classify this behavior as an anti-pattern, according to the data table. Conversely, if the user is watching mandatory instructional videos, analyzer 118 will classify this as a positive pattern based on the data table. If the user's activity does not fit into either category, the analyzer 118 will classify it as “other” rather than as an anti-pattern or positive pattern.

In at least one embodiment, after classifying activities into anti-patterns and positive patterns, the analyzer 118 calculates the time spent by the user on anti-patterns. For example, if the user spends time working on non-recommended skills and browsing the web while working on a skill, the analyzer 118 will calculate the total time associated with these activities. The time spent working on non-recommended skills is given as 60 seconds in the data fed, and the time spent browsing the web is the length of the clip. The analyzer 118 will sum these times if the user engages in both activities sequentially. If the user performs the same activity simultaneously, the analyzer 118 will record the greater of the two times.

In at least one embodiment, the analyzer 118 calculates performance metrics, which include: requiring the user to complete a minimum study time of 25 minutes across one or more online learning platforms 104. The user must spend at least 25 minutes studying the module provided by the online learning platform 104. This 25-minute requirement is cumulative, meaning that if the user studies different subjects on multiple online learning platforms 104, the combined time will be considered. For example, if a user studies a history module for 15 minutes and then studies mathematics for 15 minutes, the combined time of 30 minutes will be counted for classification. Alternatively, if the user studies both the history and mathematics modules simultaneously, spending 15 minutes on history and 16 minutes on mathematics, the longer duration of 16 minutes will be considered for classification.

An accuracy rate of at least 80% is required across all online learning platforms 104 used during the session. After completing the learning session, the user will be presented with questions. The user must answer these questions with at least 80% accuracy to qualify for positive patterns. For example, if the user has taken classes in both history and mathematics, the online learning platform 104 will present questions from both subjects. If the user has studied only one subject, the questions will be drawn from that subject. The accuracy percentage will then be calculated based on the user's responses.

Users are engaging with the appropriate learning materials, and the analyzer 118 checks if they are using the correct module for their level of study. For example, if a user is working with lower-grade material but their accuracy is high, this will not be classified as a posi-pattern. The system screens the accuracy of responses and verifies that the user is using material appropriate for their grade level or learning stage.

In operation 208, a prompt generator 122 generates a coaching prompt to guide the AI engine 124, for generating personalized coaching advice. The structure of the prompt is made by the prompt engineer. The prompt generator 122 modifies the prompt by adding different strings and values to the prompt.

The prompt generator 122 present inside the coaching advice planning module 114 collects data from the analyzer 118 and modifies the prompt for the data collected. Following is an exemplary prompt to guide and constrain the AI engine 124:

### Explanation of the Prompt Created by the Prompt Engineer:

The AI engine 124, is tasked with generating personalized coaching feedback for users using the online learning platform 104. The AI engine 124 primary responsibility is to review and analyze the performance metrics of users who have not met their learning goals. The AI engine 124 will focus on various performance metrics, such as time spent on different subjects, response accuracy, the number of units mastered, and specific behaviors observed during learning sessions.

The AI engine 124 will begin by providing an overview of each student's overall performance, giving them a clear picture of their current standing. After that, the AI engine 124 will identify and acknowledge the positive aspects of users' learning habits, such as any streaks or patterns that indicate good performance or progress.

Next, the AI engine 124 will shift focus to areas where the student needs improvement, addressing any anti-patterns that may be hindering their progress. The AI engine 124 must be specific and provide detailed examples of where the student is struggling. To make the AI engine 124 feedback more effective and actionable, the AI engine 124 will link the feedback to relevant evidence that supports observations. The AI engine 124 ultimate goal is to ensure that the feedback is clear, constructive, and actionable, following the guidelines and format provided.

In operation 210, the AI engine 124 uses the prompt generated by the prompt generator 122 to create personalized coaching advice based on classified learning patterns and performance metrics. A coaching advice generator 126, integrated within the AI engine 124, utilizes both learning patterns, including posi-patterns and anti-patterns, and performance metrics to generate this personalized advice. The coaching advice generator 126 employs a large language model (LLM) to process the prompts and produce the output. This LLM is an AI model trained on vast amounts of text data, and is designed to understand and generate human-like language, enabling it to perform tasks such as translation, summarization, and answering questions based on its learned patterns.

In at least one embodiment, the data used for training the LLM, such as GPT (Generative Pre-trained Transformer), includes the following:

| name | description | fix |
|---|---|---|
| ANTI \| Browsing or | The student navigated to | You should avoid browsing or consulting |
| using external tools | irrelevant websites or | websites or external apps while in the |
| during a skill or | opened other apps while | middle of a skill. This disrupts your |
| assessment | working on a skill | focus, slows you down and gets in the |
| | | way of optimal learning. Stay on the |
| | | skill page until you're done so you can |
| | | maximize your learning efficiency. |
| ANTI \| Excessive | The student used the | While Starting over resets your |
| starting over | “Start over” feature on | accuracy, you should not have to use |
| | exercises on which they | this feature if you have mastered the |
| | spent over five minutes | material. Instead of resetting the |
| | cumulatively | quiz, learn from your mistakes, review |
| | | the videos and articles accompanying |
| | | the unit and reattempt the quiz. |
| ANTI \| Ignoring | The student skips the | Making mistakes is normal and a great |
| explanations after | in-depth explanations | opportunity for learning something new. |
| mistakes | provided by the app for | But you will only learn if you take the |
| | incorrect answers, | time to understand what you did wrong. |
| | missing out on learning | To understand your mistakes and learn |
| | from their mistakes. | from them, make sure you ALWAYS review |
| | | the explanations provided by the app |
| | | after making a mistake. It's important |
| | | that you don't move on until you've |
| | | understood what you did wrong and how |
| | | to prevent it next time. |
| ANTI \| Rushing | The student skipped | Read the text carefully and answer the |
| Guiding Questions | guiding questions, | guiding questions to aid your |
| | resulting in low | comprehension of the text. |
| | assessment score. | |
| ANTI \| Using audio | The student is listening | You're not allowed to use the read |
| support/read aloud | to the text by using the | aloud feature and it's getting in the |
| feature for reading | “read aloud” feature | way of improving your reading skills. |
| comprehension skills | while doing a Reading | Don't use it except under exceptional |
| | skill | circumstances (guide will make the call) |
| ANTI \| Not watching | The student is not | Always watch the mandatory |
| mandatory | watching instructional | instructional videos before attempting |
| instructional videos | videos that are | to master a skill. Even when it's not |
| | presented to them as | mandatory, it's a good idea to use the |
| | mandatory before | “Learn with an example” and the “Watch |
| | attempting the skill. | video” features whenever they're |
| | | available. |
| ANTI \| Idling while | The student was idle in | When you start a skill, stay focused |
| working on a skill | the app for more than 1 | the whole time until you finish it. If |
| | minute DURING a skill | you do this, you will learn more and |
| | | faster! |
| ANTI \| Distracted | The student is chatting | Stay focused and keep your eyes on the |
| chatting to | with coleagues and not | screen while doing a skill. Do not chat |
| colleagues while | paying attention to the | with your colleagues or attend to any |
| working on a skill | skill they're attempting | personal or school matters except the |
| | to master, FOR MORE THAN | task at hand. |
| | 30 SECONDS, while the | |
| | clock is ticking. | |
| ANTI \| Leaving seat | The student left their | Stay in your seat while doing the skill |
| while working on a | seat for some time while | and put all your focus into it until |
| skill | attempting to master the | you've mastered it. |
| | skill. | |
| ANTI \| Playing with | Fooling around with the | When using the app make sure you are |
| the computer | computer with no intent | focused on mastering the skill and |
| unproductively | of mastering the skill | nothing else don't play with or use the |
| | at hand. | app for any other purpose. The faster |
| | | you complete the skill, the faster you |
| | | can go play and do other activities. |
| ANTI \| Listening to | The student is listening | Not everyone benefits from listening to |
| music while working | to music while working | music while working on complex tasks, |
| on a skill | on a skill | it varies from person to person. |
| | | Science shows that calm music without |
| | | lyrics is better for concentration. |
| | | Check carefully what works for you, you |
| | | may want to change music genre while |
| | | studying or not listen to music at all. |
| ANTI \| Working on | The student ignored | If you work on skills that are not the |
| non-recommended | skills suggested on the | ones recommended on Dash, you will |
| skills | Dash or in the | waste valuable learning time one the |
| | Personalized | wrong skills. Always select only skills |
| | Recommendations report | from Dash. |
| | and worked on other | |
| | skills they picked | |
| | manually from the app. | |
| (DEPRECATED) ANTI \| | Although the student | Always follow the order of the |
| Not following the | worked on recommended | recommended skills to get the most out |
| recommended order of | skills, they did not | of your sessions. This ensures that you |
| skills | follow the recommended | are getting all the preparation you |
| | order. | need to tackle every skill. |
| (DEPRECATED) ANTI \| | The student started a | When you leave skills unfinished and |
| Not finishing lesson | new skill without | start new ones, you interrupt your |
| before starting new | finishing an in-progress | focus and risk skipping lessons that |
| one | one. | are important for your next skills. |
| | | Always finish your skills before moving |
| | | on to new ones. |
| ANTI \| Did not take | The student did not take | Always take the IXL Diagnostic on |
| IXL Diagnostics when | the IXL Diagnostic on | Fridays to keep your recommendations up |
| required | Friday. | to date. If you miss it on Friday, take |
| | | it at the earliest opportunity. |
| ANTI \| Not taking an | Student was assigned to | When an assigned quiz shows up on the |
| assigned quiz | take a quiz but instead | Personalized Recommendations sheet, you |
| | of completing it, they | should take it before starting to work |
| | worked on regular skills | on any skills. |
| ANTI \| Repeating | The student worked on | Once you score 100% on an exercise, you |
| mastered topics | the same exercise that | cannot achieve any more mastery points |
| | they have previously | by reattempting the exercise. You |
| | scored 100% in. | should move on to solving different |
| | | exercise so that you actually progress |
| | | your learning. |
| ANTI \| Selecting | The student completed an | Select the correct article lexile |
| skills below their | article at lexile level | according to your target lexile range. |
| level (Lower Lexile) | below their target range. | |
| ANTI \| Selecting | The student manually | Do not change the lexile of the |
| skills of a | changed the level/lexile | recommended skills and articles. If you |
| different | of an article before | think the level you're working on is |
| level/lexile | attempting the quiz. | not the right one, let your guide know. |
| ANTI \| Rushing | The student spent less | Read the questions carefully, take your |
| questions and | than 20 seconds per | time when thinking through the |
| ignoring | question, ignored | solution, and doublecheck your answers |
| explanations | explanations and | before submitting them. It's better to |
| | answered incorrectly. | spent a bit more time than to rush |
| | | through and not learn. In case you make |
| | | mistakes, always read the explanations |
| | | before moving on to the next question, |
| | | so you can learn from them! |
| ANTI \| Rushing | The student did not | Read the questions carefully, take your |
| questions | ignore explanations | time when thinking through the |
| | after mistakes but spent | solution, and doublecheck your answers |
| | less than 20 seconds per | before submitting them. It's better to |
| | question and answered | spent a bit more time than to rush |
| | incorrectly. | through and not learn. |
| ANTI \| Webcam | The webcam if covered or | Whenever you cover or misposition the |
| covered or | mispositioned resulting | webcam you're making it harder for us |
| mispositioned | in not being able to see | to understand what you are struggling |
| | the student, despite the | with. Make sure the webcam is not |
| | webcam being ON. | blocked by anything and pointed in your |
| | | direction so we can give you better |
| | | coaching advice. |
| No antipatterns | Use this “AP” if zero | ′— |
| found | antipatterns are | |
| | detected after | |
| | performing the review. | |
| | Mention how many hours | |
| | of recordings you | |
| | watched to arrive at | |
| | that conclusion. | |
| POSI \| Reading | The student read the | Well done! Making mistakes is an |
| explanations after | explanations after | important part of learning, but only if |
| mistakes | making a mistake. | we learn from our mistakes! Reading the |
| | | explanations will make you learn, even |
| | | when you make a mistake. Always read |
| | | the explanations! |
| POSI \| Reading the | Reading the question | Well done! When you spend enough time |
| question carefully | carefully before | and focus on a question, you are more |
| before answering | answering and answering | likely to answer it correctly. Keep |
| correctly | it correctly. | doing that! |
| POSI \| Watching | The student watched the | Well done! Those instructional videos |
| mandatory | mandatory instructional | are important to prepare yourself for |
| instructional videos | videos. | the questions that come after. Keep |
| | | watching them, good job! |
| OTHER \| Loud or | The student is trying to | Whenever you're struggling to focus due |
| distracting | focus but the | to noise in the classroom or other |
| environment | environment around them | distractions, reach out to the guide |
| | is loud or distracting. | and express your concern and they will |
| | | fix it for you! |
| OTHER \| Student in | The student is | Trying and failing is part of the |
| distress | noticeably distressed | process of learning. Always remember |
| | (angry, crying, | that it is normal to sometimes |
| | agitated) about | experience difficulties understanding |
| | something. It could be | or answering questions correctly. If |
| | frustration towards not | you ever feel distressed or anxious, |
| | being able to complete | take a deep breath, stay positive and |
| | or understand the skill | don't give up. Practice makes perfect! |
| | at hand or something | If you need them, guides are always |
| | else. | around to give you support. |
| POSI \| Following the | The student picks the | Good job! Following the correct order |
| correct order of | skill in the correct | of skills recommended will ensure you |
| recommendations | order. | are learning and progressing in the |
| | | best possible way. Keep doing that! |
| ANTI \| | Opening other browser | When you start a skill, you should stay |
| Surfing/Browsing the | tabs that are not | 100% focused until the end. |
| web while working on | related to the skill | Surfing/Browsing the web for unrelated |
| a skill | they are working on, and | content while trying to master a skill |
| | spending more than 10 | will only distract you and interrupt |
| | seconds doing it. | your flow. Stay focused until the skill |
| | | is done and surf the web later. |
| ANTI \| (Knewton) | The student does not | Always complete the Review Center |
| Skipping Review | complete the Review | (available under each assessment) |
| Center | Center (available under | before retaking a Quiz or Test. |
| | each assessment) before | |
| | retaking a Quiz or Test | |
| | (not applicable for | |
| | Assignments or Learning | |
| | Objectives) | |
| ANTI \| Rushing | The student is rushing | Taking the time to read the whole text |
| through reading | through reading | carefully before reading the quiz |
| comprehension texts | comprehension texts | questions is key to training your |
| | (spending less than 4 | reading comprehension. Your goal must |
| | minutes, including time | always be to absorb as much as possible |
| | spent on Commonlit's | of the text so that you can answer any |
| | guiding questions) | question about it correctly at the |
| | before reading the final | first attempt. Take enough time to read |
| | quiz questions, while | the text. |
| | having accuracy below | |
| | 80% on the quiz. | |
| ANTI \| Using audio | The student is using the | The audio support feature does not |
| support without | audio support feature | replace the need for reading the text |
| reading along | but is not reading the | carefully. If you use the audio |
| | respective text along. | support, always read the respective |
| | | text along. |
| ANTI \| Not finishing | The student selects a | When you leave skills unfinished and |
| skill before | skill from Dash that is | start new ones, you interrupt your |
| starting a new one | below a partially non- | focus and risk skipping lessons that |
| | mastered recommended | are important for your next skills. |
| | skill. | Always finish your skills before moving |
| | | on to new ones. |
| ANTI \| Not following | Although the student | Always follow the order of the |
| the recommended | worked on recommended | recommended skills to get the most out |
| order of skills | skills, they did not | of your sessions. This ensures that you |
| | follow the recommended | are getting all the preparation you |
| | order. | need to tackle every skill. |
| ANTI \| Multiple | Multiple people were | Make sure you do the learning work on |
| people detected | detected working on a | your own, without unauthorized help. |
| | skill. | This ensures you'll learn effectively. |

For example, when the prompt is modified by the prompt generator 122, wherein the analyzer 118 detects an anti-pattern such as “Multiple people detected”, the coaching advice generator 126 inside the AI engine will give an output similar to “Make sure you do the learning work on your own, without unauthorized help. This ensures you'μl learn effectively.”

Because of the data used for the training of LLM in the coaching advice generator, the online learning platform 104 displays the generated personalized coaching advice to the user. The online learning platform receives personalized coaching advice from the coaching advice generator 126 and displays personalized coaching advice through the user interface 106 in the online learning platform 104.

Provided Below is the Pseudocode for this Disclosure:

```
// Function to recognize patterns in media stream data
using ML and MMLM models
Function RecognizePatterns(media_stream_data):
  patterns =
ML_Model.RecognizePatterns(media_stream_data)
  patterns +=
MMLM_Model.RecognizePatterns(media_stream_data)
  return patterns
// Function to apply deterministic rules to tracker data
points
Function ApplyDeterministicRules(tracker_data):
  foreach data_point in tracker_data:
    if data_point meets predefined_criteria:
      MarkAsImportant(data_point)
    else:
      MarkAsNormal(data_point)
// Function to translate antipattern data into time wastage
Function TranslateAntipatternsToTimeWastage(patterns,
tracker_data):
  time_wastage = 0
  foreach pattern in patterns:
    if pattern is an antipattern:
      time_wastage += CalculateWastage(pattern)
  foreach data_point in tracker_data:
    if data_point is an antipattern:
      time_wastage += CalculateWastage(data_point)
  StoreTimeWastageData(time_wastage)
  return time_wastage
// Function to aggregate data points
Function AggregateData(patterns, tracker_data):
  aggregated_data = patterns + tracker_data
  return aggregated_data
// Function to generate coaching advice using LLM
Function GenerateCoachingAdvice(aggregated_data):
prompt = CreatePrompt(aggregated_data,
Coaching_Recommendations)
  coaching_advice = LLM_Model.GenerateAdvice(prompt)
  return coaching_advice
// Main function to process media stream data and generate
coaching advice
Function ProcessMediaStreamData(media_stream_data,
tracker_data):
  patterns = RecognizePatterns(media_stream_data)
  ApplyDeterministicRules(tracker_data)
  time_wastage =
TranslateAntipatternsToTimeWastage(patterns, tracker_data)
  aggregated_data = AggregateData(patterns, tracker_data)
  coaching_advice =
GenerateCoachingAdvice(aggregated_data)
  return coaching_advice
// Example usage
media_stream_data = GetMediaStreamData( )
tracker_data = GetTrackerData( )
coaching_advice = ProcessMediaStreamData(media_stream_data,
tracker_data)
DisplayCoachingAdvice(coaching_advice)
```

The pseudocode outlines the personalized coaching advice generation method. The personalized coaching advice generation method begins with the ‘RecognizePaerns’ function, which uses both ML and MMLM to identify patterns in the media stream data. These models work in tandem to extract meaningful patterns from the input. Next, the ‘ApplyDeterministicRules’ function processes tracker data points. ‘ApplyDeterministicRules’ evaluates each data point against predefined criteria, marking important points accordingly. This step helps prioritize and categorize the user interaction data 112 for further analysis.

The ‘TranslateAntipaernsToTimeWastage’ function then assesses the identified patterns and the user interaction data 112 for antipatterns-behaviors or patterns that lead to time wastage. ‘TranslateAntipaernsToTimeWastage’ calculates the total time wasted based on these anti-patterns and stores this information for later use. The 'AggregateData, function combines the recognized patterns and the user interaction data 112 into a single dataset. This aggregation prepares the data for the final analysis and advice generation step.

Finally, the ‘GenerateCoachingAdvice’ function uses a Large Language Model (LLM) to produce personalized coaching recommendations. The ‘GenerateCoachingAdvice’ creates prompt based on the aggregated data and coaching recommendations, then uses this prompt to generate tailored advice. The ‘ProcessMediaStreamData’ function coordinates this entire process. The ‘ProcessMediaStreamData’ calls each of the previously described functions in sequence, passing data between them as needed. The ‘ProcessMediaStreamData’ function takes in the raw media stream and tracker data and outputs the final coaching advice.

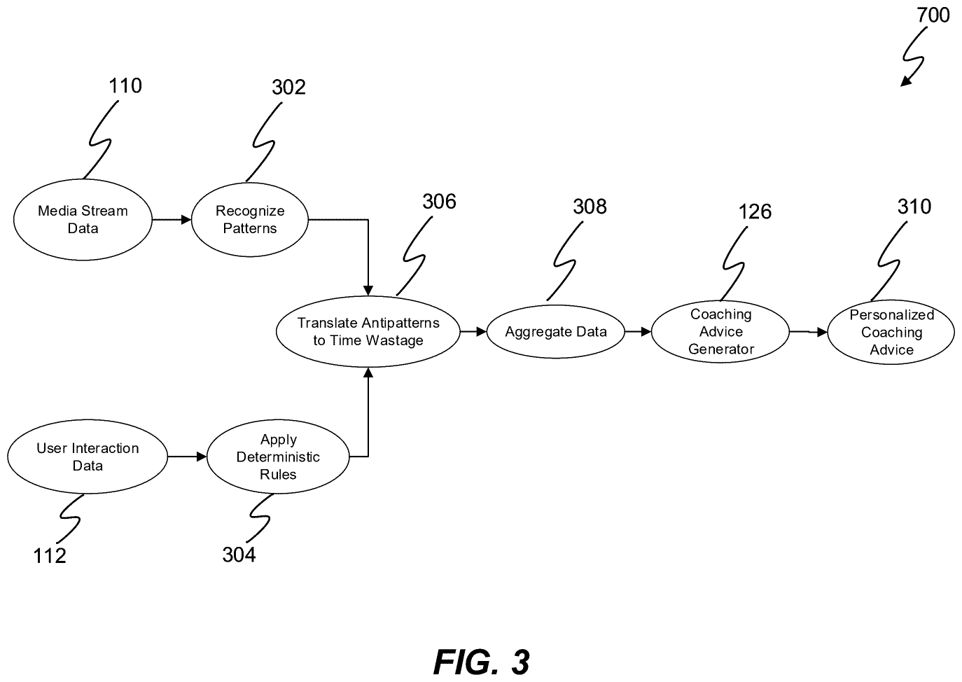

FIG. 3 depicts a flow for the personalized coaching advice generation 300 system, which is an embodiment of the personalized coaching advice generation method of FIG. 2. The process starts by collecting the media stream data 110 and the user interaction data 112, which are fed into different analysis stages. The media stream data 110 is directed towards the recognize patterns 302 node, where patterns within the media stream data 110 are identified. Simultaneously, the user interaction data 112 is sent to the apply deterministic rules 304 node, where predefined rules are applied to interpret the data.

Once patterns are recognized and deterministic rules are applied, the results from both are sent to translate antipatterns to time wastage 306 node. Where, any identified antipatterns—inefficient or unproductive behaviors-are translated into measurable instances of time wastage. The outcomes of this translation are then passed on to the aggregate data 308 node, which consolidates all the relevant information. The aggregated data 308 is then processed by a LLM in the coaching advice generator 126 node, where personalized coaching advice is created based on the insights derived from the previous stages. Finally, the generated coaching advice is outputted to the personalized coaching advice 310 node, where it is ready to be delivered to the user, providing actionable recommendations based on their behavior and performance data.

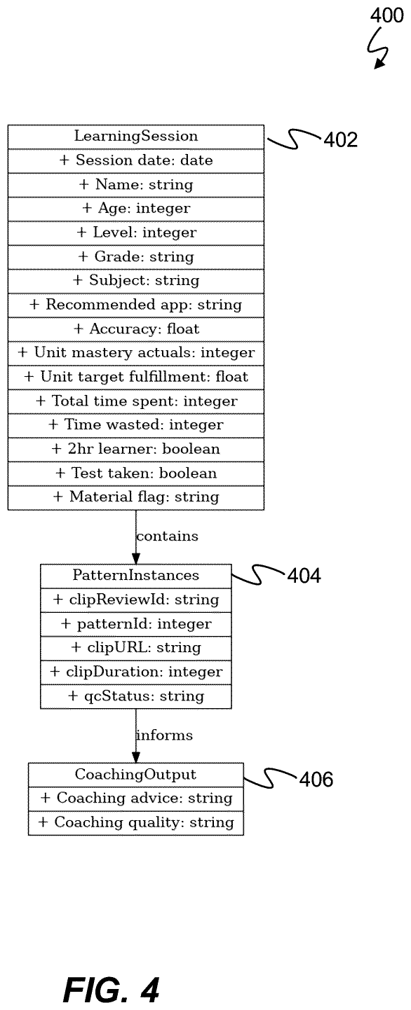

FIG. 4 depicts a data structure for personalized coaching advice generation 400. A LearningSession 402 contains several attributes related to a learning session. These attributes include session-specific details such as the session date, the learner's name, age, level, grade, subject studied, and the recommended app for learning. The LearningSession 402 also tracks performance metrics like accuracy, unit mastery actuals, unit target fulfillment, total time spent, time wasted, whether the learner qualifies as a 2-hour learner, if a test was taken, and any material flags.

The LearningSession 402 is linked to a PatternInstances 404, which holds information about specific pattern instances identified during the learning session. These patterns are recorded with attributes such as a unique clip review ID, pattern ID, the URL of the clip, the duration of the clip, and the quality control status. The relationship between the LearningSession 402 and PatternInstances 404 is defined by the “contains” label, indicating that a learning session contains multiple pattern instances.

The PatternInstances 404 is connected to the CoachingOutput 406, which represents the coaching advice generated from the analysis of these patterns. The attributes of CoachingOutput 406 include the actual coaching advice given and the quality of that coaching advice. The relationship here, labeled “informs,” indicates that the pattern instances provide the data necessary to inform the coaching output.

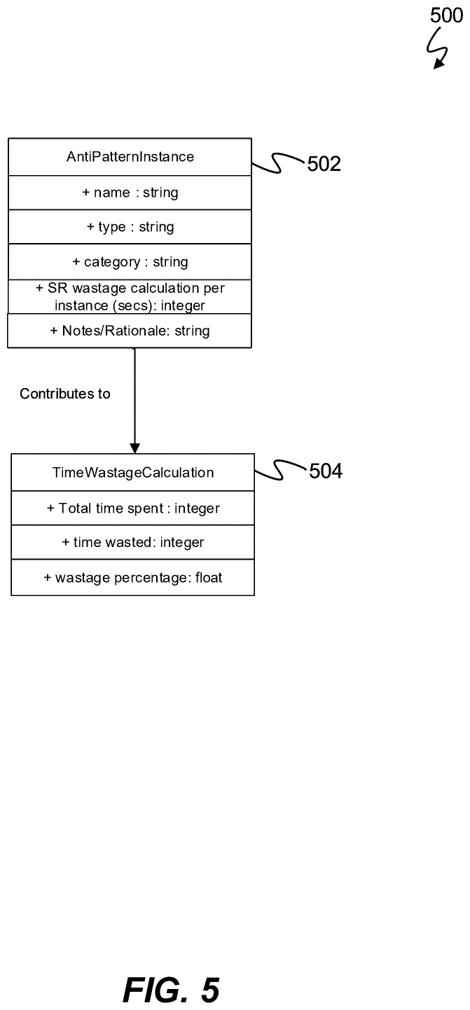

FIG. 5 depicts a data structure for a time waste calculator 500. In the Learning Time Waste Calculator data structure, an AntiPatternInstance 502 node describes attributes related to anti-patterns, which are inefficient behaviors during learning sessions. Each anti-pattern instance has a name, type, category, and the calculated time wastage per instance in seconds, along with additional notes or rationale. The AntiPatternInstance 502 node is linked to a Time WastageCalculation 504 node, which aggregates the total time spent, the time wasted, and the wastage percentage. The connection between AntiPatternInstance and

Time WastageCalculation is labeled “contributes to,” indicating that the identified anti-pattern instances contribute to the overall time wastage calculation.

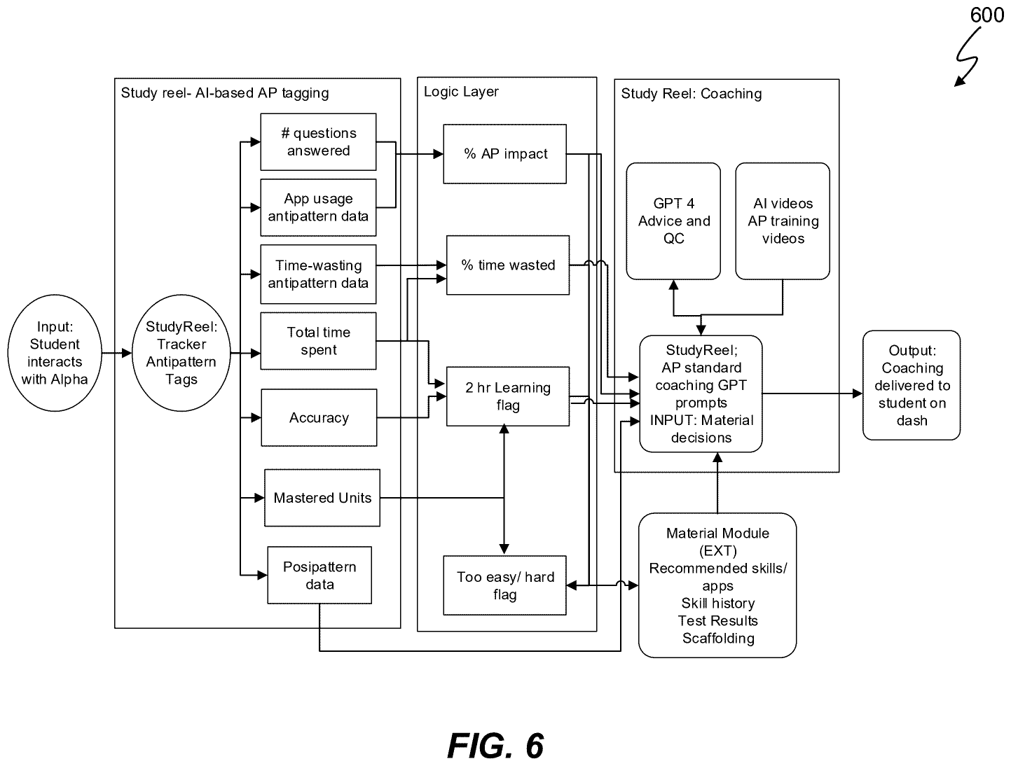

FIG. 6 depicts a representation of an educational tool named ‘StudyReel’ for the personalized coaching advice generation system 600, which is an embodiment of the personalized coaching advice generation method of FIG. 2. The ‘StudyReel’ utilizes the coaching advice planning module 114 and AI engine 124 for personalized coaching advice generation. The diagram outlines the logic flow for user interactions through various modules and data analysis points, resulting in targeted coaching outcomes. [FOR INVENTORS: PLEASE PROVIDE MORE INFORMATION]

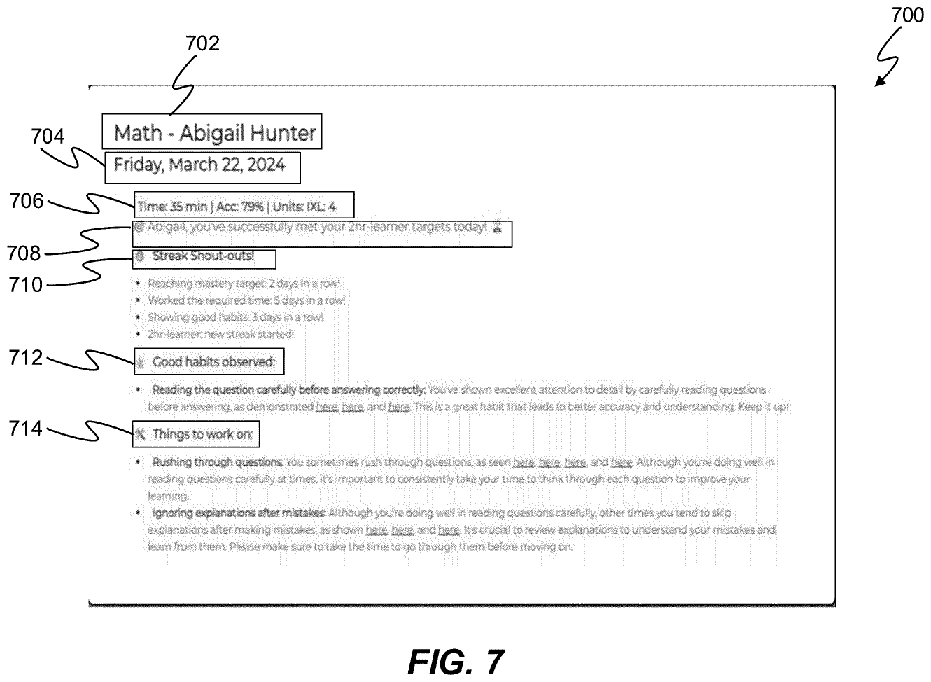

FIG. 7 depicts an exemplary user interface 700 for displaying personalized coaching advice (700) within the online learning platform 104. The interface provides detailed personalized coaching advice on a user's activities and progress, offering insights into their strengths and areas for improvement. Part 702 covers the course title and user name and displays the course title (Math) and the user's name (“Abigail Hunter”). Part 704 covers date; the date (“Friday, Mar. 22, 2022”) indicates when the feedback was generated. Part 706 covers time spent, accuracy, and units completed, Part 706 of the user interface 106 shows a summary of the users performance, including the time spent (35 minutes), accuracy (79%), and the number of units completed (4 units). Part 708 has personalized messages. For example, a congratulatory message acknowledges the user's achievement, highlighting that Abigail has met her 2-hour user targets for the day.

Part 710 shows streak shout-outs, the part 710 celebrates specific achievements in maintaining learning streaks, such as reaching mastery targets, consistent study time, and showing good habits. For example, Abigail has maintained a streak of 2 days for reaching the mastery target and 3 days for exhibiting good study habits. Part 712 shows good habits observed, the part 712 lists positive behaviors observed during the learning session, such as “reading the question carefully before answering correctly.” Reinforces these behaviors by linking to examples for further clarity. Part 714 shows things to work on; the part 714 provides constructive feedback on areas where the user could improve, such as “Rushing through questions” and “Ignoring explanations after mistakes.” Each point includes hyperlinks to examples to help the user understand the issues better.

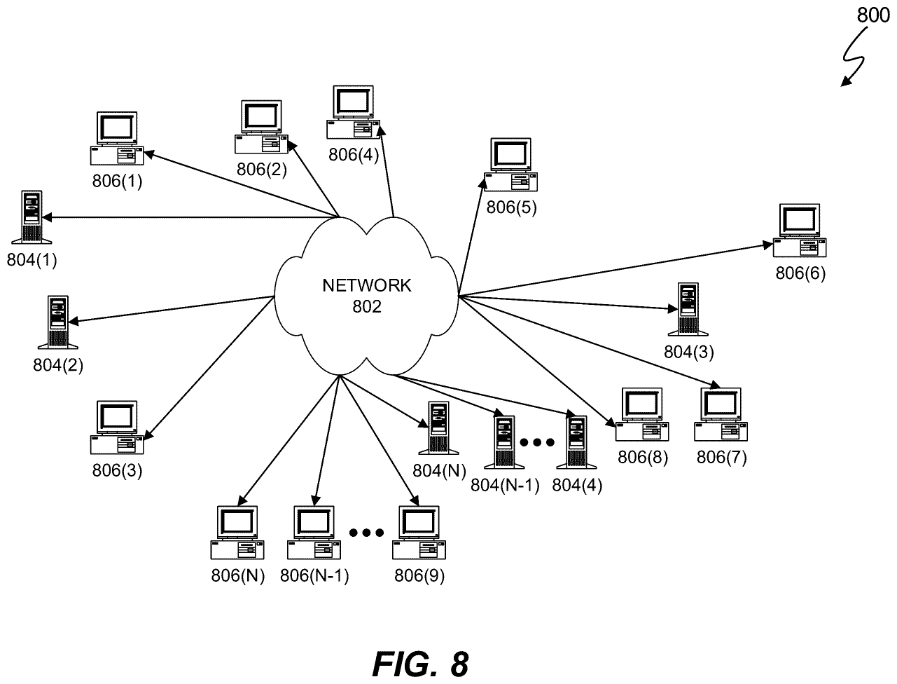

FIG. 8 is a block diagram illustrating a network environment in which a personalized coaching advice generation system 100 and personalized coaching advice generation method 200 may be practiced. Network 802 (e.g. a private wide area network (WAN) or the Internet) includes a number of networked server computer systems 804 (1)-(N) that are accessible by client computer systems 806(1)-(N), where N is the number of server computer systems connected to the network. Communication between client computer systems 806(1)-(N) and server computer systems 804 (1)-(N) typically occurs over a network, such as a public switched telephone network over asynchronous digital subscriber line (ADSL) telephone lines or high-bandwidth trunks, for example communications channels providing T1 or OC3 service. Client computer systems 806(1)-(N) typically access server computer systems 804 (1)-(N) through a service provider, such as an internet service provider (“ISP”) by executing application specific software, commonly referred to as a browser, on one of client computer systems 806(1)-(N).

Client computer systems 806(1)-(N) and/or server computer systems 804(1)-(N) are specialized computer programmed to improve conventional computer systems to implement and utilize the personalized coaching advice generation system 100 and personalized coaching advice generation method 200. The type of computer system that can be specially programmed to implement and utilize the personalized coaching advice generation system 100 and personalized coaching advice generation method 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the personalized coaching advice generation system 100 and personalized coaching advice generation method 200 can be implemented using code stored in a tangible, non-transient computer readable medium and executed by one or more processors. In at least one embodiment, the personalized coaching advice generation system 100 and personalized coaching advice generation method 200 can be implemented completely in hardware using, for example, logic circuits and other circuits including field programmable gate arrays.

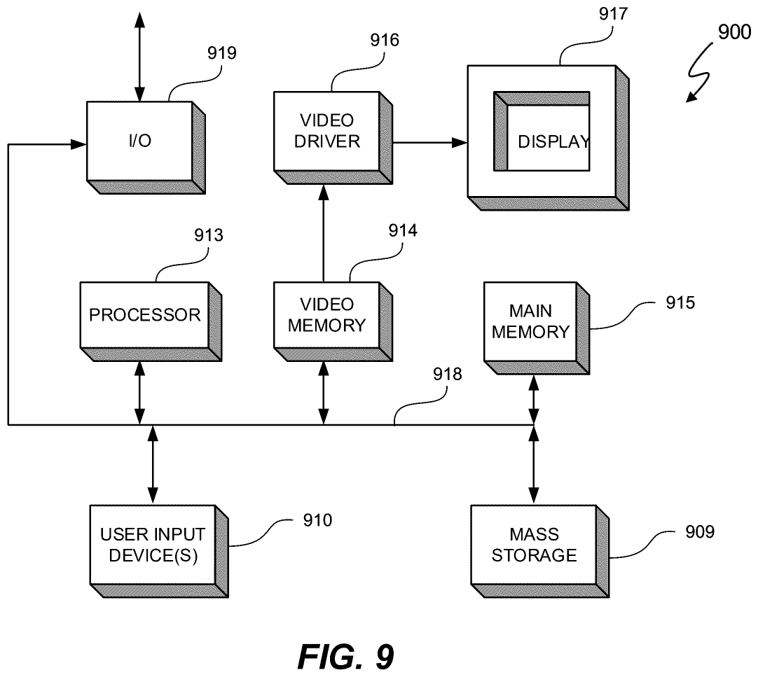

Embodiments of the personalized coaching advice generation system 100 and personalized coaching advice generation method 200 can be implemented on a computer system such as a special-purpose, special-programmed computer 900 illustrated in FIG. 9. Input user device(s) 910, such as a keyboard and/or mouse, are coupled to a bi-directional system bus 918. The input user device(s) 910 are for introducing user input to the computer system and communicating that user input to processor 913. The computer system of FIG. 9 generally also includes a non-transitory video memory 914, non-transitory main memory 915, and non-transitory mass storage 909, all coupled to bi-directional system bus 918 along with input user device(s) 910 and processor 913. The mass storage 909 may include both fixed and removable media, such as a hard drive, one or more CDs or DVDs, solid state memory including flash memory, and other available mass storage technology. Bus 918 may contain, for example, 32 of 64 address lines for addressing video memory 914 or main memory 915. The system bus 918 also includes, for example, an n-bit data bus for transferring DATA between and among the components, such as CPU 909, main memory 915, video memory 914 and mass storage 909, where “n” is, for example, 32 or 64. Alternatively, multiplex data/address lines may be used instead of separate data and address lines.

I/O device(s) 919 may provide connections to peripheral devices, such as a printer, and may also provide a direct connection to a remote server computer systems via a telephone link or to the Internet via an ISP. I/O device(s) 919 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 909, into main memory 915 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 913, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 915 is comprised of dynamic random access memory (DRAM). Video memory 914 is a dual-ported video random access memory. One port of the video memory 914 is coupled to video amplifier 916. The video amplifier 916 is used to drive the display 917. Video amplifier 916 is well known in the art and may be implemented by any suitable means. This circuitry converts pixel DATA stored in video memory 914 to a raster signal suitable for use by display 917. Display 917 is a type of monitor suitable for displaying graphic images.

The computer system described above is for purposes of example only. The personalized coaching advice generation system 100 and personalized coaching advice generation method 200 may be implemented in any type of computer system or programming or processing environment. It is contemplated that the personalized coaching advice generation system 100 and personalized coaching advice generation method 200 might be run on a stand-alone computer system, such as the one described above. The personalized coaching advice generation system 100 and personalized coaching advice generation method 200 might also be run from a server computer systems system that a plurality of client computer systems can access interconnected over an intranet network. Finally, the personalized coaching advice generation system 100 and personalized coaching advice generation method 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding an Artificial Intelligence (AI) engine for generating personalized coaching advice for users using an online learning platform based on user interaction data, and learning patterns, the method comprises:
executing code using one or more processors of a computer system to cause the computer system to perform operations comprising:
collecting media stream data, and user interaction data, wherein the media stream data includes webcam feed, microphone audio, screen captures, and system audio, and user interaction data includes keystrokes, mouse clicks, URLs visited, active application data, active window data, and window titles;
analyzing the collected data by utilizing machine learning algorithms to identify the specific learning patterns of the user;
classifying the analyzed data into positive learning patterns (posi-patterns) and negative learning patterns (anti-patterns), wherein classifying the data into positive and negative learning patterns includes identifying one or more matching learning patterns corresponding to the analyzed data;
generating a coaching prompt to guide the AI engine to generate the personalized coaching advice for the user based on the analyzed insights and a prompt structure, wherein the prompt structure is generated by a prompt engineer using prompt engineering techniques;
utilizing the generated coaching prompts by the AI engine to
generate the personalized coaching advice based on the classified learning patterns;
displaying the generated personalized coaching advice to the user using the online learning platform, wherein the personalized coaching advice addresses specific behaviors detected during the user's online learning session and suggests corrective actions to improve learning efficiency.

2. The method of claim 1 wherein the collection of the user interaction data includes recording the duration of user inactivity and identifying periods of low engagement to detect anti-pattern and trigger coaching advice that re-engages the user.

3. The method of claim 1 wherein the analyzed data is processed on a daily batch process to generate next-day personalized coaching advice for the user.

4. The method of claim 1 wherein the media stream data and user interaction data are stored in a first database for future retrieval and are collected daily.

5. The method of claim 1 wherein determining the anti-patterns during the online learning session comprises:
a set number of window switches per minute;
a period of inactivity by the user exceeding a threshold time period;
use of non-educational applications for a pre-defined amount of time.

6. The method of claim 1 wherein the AI engine utilizes pre-trained LLM that are configured to:
generate contextually appropriate coaching advice based on the collected data and detected patterns;
translate the determined anti-patterns into learning time wastage by calculating the duration of the anti-pattern.

7. The method of claim 1 wherein the AI engine utilizes trained machine learning (ML) and multimodal machine learning (MMLM) models configured to:
utilize the trained models to analyze media stream data, including webcam, microphone, screen captures, and system audio, to detect behavioral patterns indicating focus, distraction, or disengagement from learning activities; recognize the learning patterns in the media stream data and the user interaction data;
classify the detected patterns as either posi-patterns or anti-patterns.

8. The method of claim 1 wherein the online learning sessions include:
a minimum study time of 25 minutes across one or more online learning platforms;
an accuracy rate of at least 80% across all online learning platforms used during the online learning session;
mastery of a required number of units within the online learning platforms used, wherein the mastery requirement varies with online learning platforms but is cumulative across all applications used during the study session.

9. The method of claim 1 further comprises:
calculating the learning time wastage based on the anti-patterns detection, wherein the learning time wastage is calculated based on the number and duration of the anti-patterns detected for the user during the online learning session.

10. The method of claim 9 further comprises:
collecting anti-pattern data from both the AI analysis and the pre-defined and threshold values, wherein the detected anti-patterns are associated with specific periods when the user is not paying attention during the online learning session;
calculating time wastage by aggregating the duration of anti-pattern occurrences, wherein each detected anti-pattern is assigned a time period that represents unproductive learning time;
storing the learning time wastage in a second database, where the data can be accessed by subsequent processing modules for generating coaching prompts.

11. The method of claim 1 wherein collection and calculation of data points comprises:
aggregating the media stream data, user interaction data, anti-pattern detection results, and learning time wastage into a third database;
populating the third database with information relevant to the user's daily study performance, including time spent, number of units mastered, accuracy rate, detected anti-patterns, and posi-patterns;
utilizing the aggregated data for generating personalized coaching based on the user's overall performance and detected learning patterns.

12. A system to guide an Artificial Intelligence (AI) engine to generate personalized coaching advice for a user using an online learning platform based on user interaction data and learning patterns comprises:
one or more processors of a computer system; and
one or more memories, coupled to the one or more processors, that store code and execution of the code by the one or more processors causes the computer system to perform operations comprising:
collecting media stream data and user interaction data, via a data collector, wherein the media stream data includes webcam feed, microphone audio, screen captures, and system audio, and user interaction data includes keystrokes, mouse clicks, URLs visited, active application data, active window data, and window titles;
analyzing the collected data, via an analyzer, by utilizing machine learning algorithms to identify specific learning patterns of the user;
classify the analyzed data into positive learning patterns (posi-patterns) and negative learning patterns (anti-patterns), wherein classifying the data into positive and negative learning patterns includes identifying one or more matching learning patterns corresponding to the analyzed data;
generating a coaching prompt to guide the AI engine, via a prompt generator, to generate personalized coaching advice for the user based on the identified one or more learning patterns and a prompt structure, wherein the prompt structure is generated by a prompt engineer using prompt engineering techniques;
utilizing the generated coaching prompts by the AI engine to generate personalized coaching advice based on the classified learning patterns using a coaching advice generator; and
displaying the generated personalized coaching advice to the user, via a user interface, wherein the personalized coaching advice addresses specific behaviors detected during the user's online learning session and suggests corrective actions to improve learning patterns.

13. The system of claim 12 further comprises a hyperlink, shown to the user via the user interface, where the hyperlink provides access to the exact timestamp when positive learning patterns (posi-patterns) and negative learning (anti-patterns) patterns are detected.

14. The system of claim 12 wherein the display module presents the online learning session details to the user including mastery status of the user, number of posi-patterns, details of online test, and online learning session.

15. The system of claim 12 wherein execution of the code by the one or more processors causes the computer system to perform further operations comprising:
calculating the learning time wastage using a learning time wastage calculator based on the anti-patterns detection, wherein the learning time wastage is calculated based on the number and duration of the anti-patterns detected for the user during the online learning session.

16. The system of claim 12 wherein the coaching advice generator utilizes LLM produces coherent and contextually appropriate coaching advice based on the aggregated structure and detected patterns.

17. The system of claim 12 wherein the generated personalized coaching advice is presented the next day to the user when the user logs in to the online learning platform.
